(19) United States
(12) Patent Application Publication
(10) Pub. No.: US 2022/0310119 A1
(43) Pub. Date: Sep. 29, 2022

(54) MAGNETIC RECORDING MEDIUM AND MAGNETIC STORAGE APPARATUS

(71) Applicant: SHOWA DENKO K.K., Tokyo (JP)

(72) Inventors: Takehiro YAMAGUCHI, Chiba (JP); Hisato SHIBATA, Chiba (JP); Takayuki FUKUSHIMA, Chiba (JP); Chen XU, Chiba (JP)

(21) Appl. No.: 17/650,119

(22) Filed: Feb. 7, 2022

(30) Foreign Application Priority Data
Mar. 26, 2021 (JP) 2021-053351

(51) Int. Cl. G11B 5/73; G11B 5/012

(52) U.S. Cl. CPC G11B 5/73; G11B 5/012

(57) ABSTRACT

A magnetic recording medium includes a substrate, an underlayer provided on the substrate and including MgO, and a magnetic layer provided on the underlayer and including an alloy having a L1₀ crystal structure. The magnetic layer includes first, second, and third magnetic recording layers successively provided in this order above the underlayer. A Curie temperature of the second magnetic recording layer is lower than a Curie temperature of each of the first and third magnetic recording layers, by a value which falls within a range of 30 K to 100 K. An average grain diameter of magnetic grains at a bottom surface portion of the first magnetic recording layer is smaller by 15% or more than average grain diameters of magnetic grains at bottom surface portions of the second and third magnetic recording layers.

### CROSS-REFERENCE TO RELATED APPLICATIONS

This application is based upon and claims priority to Japanese Patent Application No. 2021-053351 filed on Mar. 26, 2021, the entire contents of which are incorporated herein by reference.

### BACKGROUND OF THE INVENTION

1. Field of the Invention

The present disclosure relates to magnetic recording media, and magnetic storage apparatuses.

2. Description of the Related Art

Generally, a magnetic recording medium includes an underlayer, a magnetic layer, and a protection layer which are successively laminated or stacked on a substrate. A thermal assist recording method and a microwave assist recording method are methods of recording magnetic information on the magnetic recording medium, which irradiate laser light or microwave on the magnetic recording medium, to locally reduce the coercivity of the magnetic recording medium. The thermal assist recording method and the microwave assist recording method can realize a surface recording density on the order of 2 Tbit/inch². Hence, the thermal assist recording method and the microwave assist recording method are regarded as promising next generation recording methods, which can increase the storage capacity by reducing the size and thickness of the magnetic recording medium and increasing the recording density of the magnetic recording medium.

A magnetic recording medium which can be used for the thermal assist recording method, is proposed in Japanese Laid-Open Patent Publication No. 2016-026368, for example. The proposed magnetic recording medium includes a substrate, a plurality of underlayers famed on the substrate, and a magnetic layer including an alloy having an L1₀ crystal structure as a main component thereof. The plurality of underlayers includes a NiO underlayer, and an orientation control layer. In this magnetic recording medium, the orientation control layer includes an underlayer formed of an alloy having a BCC crystal structure, and an underlayer famed of MgO or the like having a NaCl crystal structure, so as to promote a (100) orientation of the NiO underlayer.

When a FePt alloy having the L1₀ crystal structure is used for the magnetic layer of the magnetic recording medium, a (001) plane is used as a crystal orientation plane of the magnetic layer. Generally, a (100) oriented MgO is often used for the underlayer, in order to cause the (001) orientation of the FePt alloy. In other words, because the (100) plane of MgO is highly lattice-matched to the (001) plane of the FePt alloy, by depositing the magnetic layer including the FePt alloy at a location above the MgO layer, the FePt alloy becomes easily (001) oriented. In addition, in the magnetic recording medium proposed in Japanese Laid-Open Patent Publication No. 2016-026368, because the NiO underlayer is also (100) oriented, MgO is used for the orientation control layer of the underlayer.

The lattice constant of FePt is 0.39 nm, while the lattice constant of MgO is 0.42 nm, and thus, a slight lattice mismatch mismatch (or misfit) occurs when the FePt film is epitaxially grown on the MgO film, thereby generating tensile stress in the FePt film. Because the tensile stress generated in the FePt film acts to increase the FePt grain size, the magnetic grain size is increased, thereby increasing the possibility of deteriorating the electromagnetic conversion characteristics of the magnetic recording medium, and impeding the high recording density of the magnetic recording medium. In addition, when the magnetic grain size is further increased and the contact area of the magnetic grains increases, such magnetic grains are more likely to be subjected to large stress, thereby even further increasing the magnetic grain size, and increasing the crystal grain size variation, and there is a high possibility of deteriorating the electromagnetic conversion characteristics of the magnetic recording medium.

### SUMMARY OF THE INVENTION

One aspect of the embodiments is to provide a magnetic recording medium having excellent electromagnetic conversion characteristics, and to provide a magnetic storage apparatus having such a magnetic recording medium.

According to one aspect of the embodiments, a magnetic recording medium includes a substrate; an underlayer, provided on the substrate, and including MgO; and a magnetic layer, provided on the underlayer, and including an alloy having an L1₀ crystal structure, wherein the magnetic layer includes three or more magnetic recording layers including a first magnetic recording layer, a second magnetic recording layer, and a third magnetic recording layer which are successively provided in this order above the underlayer, wherein a Curie temperature of the second magnetic recording layer is lower than Curie temperatures of the first magnetic recording layer and the third magnetic recording layer, and is lower than each of the Curie temperatures of the first magnetic recording layer and the third magnetic recording layer by a value which falls within a range of 30 K to 100 K, and wherein an average grain diameter of magnetic grains of the first magnetic recording layer at a bottom surface portion of the first magnetic recording layer, is smaller by 15% or more than average grain diameters of magnetic grains of the second magnetic recording layer and the third magnetic recording layer at bottom surface portions of the second magnetic recording layer and the third magnetic recording layer.

According to a further aspect of the embodiments, a magnetic storage apparatus includes the magnetic recording medium described immediately above; and a magnetic head configured to write information to and read information from the magnetic recording medium.

Other objects and further features of the present invention will be apparent from the following detailed description when read in conjunction with the accompanying drawings.

### BRIEF DESCRIPTION OF THE DRAWINGS

FIG. 1 is a cross sectional view illustrating an example of a configuration of a magnetic recording medium according to one embodiment.

FIG. 2 is a TEM photograph illustrating an example of a cross section of the magnetic recording medium according to one embodiment.

FIG. 3 is a perspective view illustrating an example of a magnetic storage apparatus using the magnetic recording medium according to one embodiment.

FIG. 4 is a schematic diagram illustrating an example of a magnetic head.

### DESCRIPTION OF THE PREFERRED EMBODIMENTS

A description will be given of embodiments and exemplary implementations of a magnetic recording medium according to the present invention, and a magnetic storage apparatus according to the present invention, by referring to the drawings. In order to facilitate understanding of the description, the same constituent elements in the drawings are designated by the same reference numerals, and a repeated description of the same constituent elements will be omitted. In addition, the drawings may not necessarily be drawn to scale, and the scale may be different from the actual scale. Furthermore, a numerical range of A to B includes the value A as a lower omit of the numerical range, and the value B as an upper limit of the numerical range, unless indicated otherwise.

[Magnetic Recording Medium]

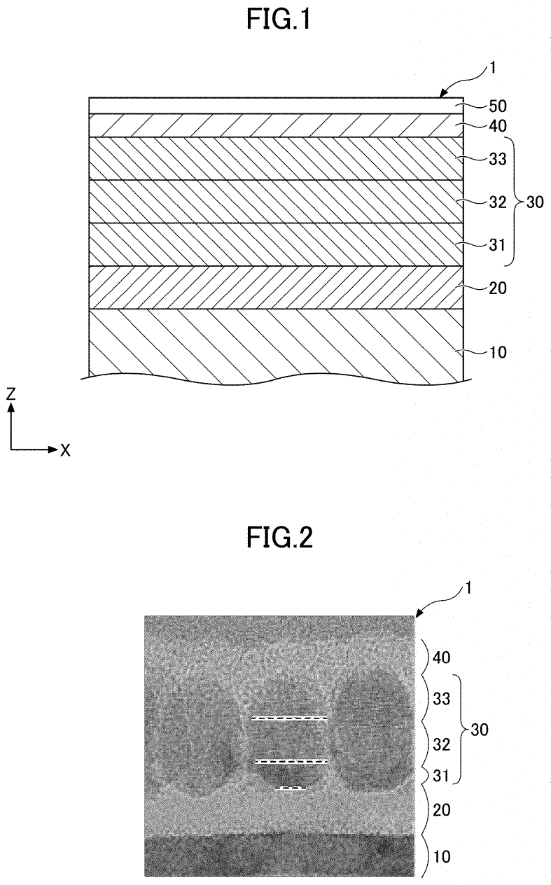

FIG. 1 is a cross sectional view illustrating an example of a configuration of the magnetic recording medium according to one embodiment. As illustrated in FIG. 1, a magnetic recording medium 1 includes a substrate 10, an underlayer 20 which is laminated on an upper surface of the substrate 10, and a magnetic layer 30 which is laminated on an upper surface of the underlayer 20. As will be described later, the magnetic layer 30 includes a first magnetic recording layer 31, a second magnetic recording layer 32, and a third magnetic recording layer 33 which are successively laminated on the underlayer 20.

In the present specification, a thickness direction (vertical direction) of the magnetic recording medium 1 may also be referred to as the Z-axis direction, and a lateral direction (horizontal direction) perpendicular to the thickness direction may also be referred to as the X-axis direction. A direction toward the side of the magnetic layer 30 along the Z-axis direction may also be referred to as the +Z-axis direction, and a direction toward the side of the substrate 10 may also be referred to as the -Z-axis direction. For the sake of convenience, the +Z-axis direction may also be referred to as the up or upward direction, and the -Z-axis direction may also be referred to as the down or downward direction in the following description, but such a directional orientation does not represent a universal vertical relationship.

FIG. 1 illustrates only the underlayer 20 and the magnetic layer 30 provided above the substrate 10. However, the magnetic recording medium 1 also includes an underlayer 20 and a magnetic layer 30 provided under the substrate 10. More particularly, the magnetic recording medium 1 includes the substrate 10, a first underlayer 20 which is laminated on the upper surface of the substrate 10, a first magnetic layer 30 which is laminated on the upper surface of the first underlayer 20, a second underlayer 20 which is laminated on a lower surface of the substrate 10, and a second magnetic layer 30 which is laminated on a lower surface of the second underlayer 20.

Because the magnetic recording medium 1 includes the first underlayer 20 and the first magnetic layer 30 successively laminated on the upper surface of the substrate 10, and the second underlayer 20 and the second magnetic layer 30 successively laminated on the lower surface of the substrate 10, information can be recorded on and reproduced from (that is, written to and read from) both the upper and lower surfaces of the magnetic recording medium 1 to perform a double-sided recording. However, the magnetic recording medium 1 may include the underlayer 20 and the magnetic layer 30 successively laminated on only one of the upper and lower surfaces of the substrate 10, and in this case, the information can be recorded on and reproduced from only one surface of the magnetic recording medium 1 to perform a single-sided recording.

A material forming the substrate 10 is not particularly limited, as long as the material usable in the magnetic recording medium 1. Examples of the material forming the substrate 10 include aluminum alloys, such as AlMg alloys or the like, soda glass, aluminosilicate-based glass, amorphous glass, silicon, titanium, ceramics, sapphire, quartz, resins, or the like, for example. Among these materials, glass, such as Al alloys, crystallized glass (or glass ceramics), amorphous glass, or the like, are preferably used for the substrate 10.

When manufacturing the magnetic recording medium 1, the substrate 10 may be heated to a temperature of 500° C. or higher. For this reason, a heat-resistant glass substrate having a softening temperature of 500° C. or higher, and preferably 600° C. or higher, is preferably used for the substrate 10.

The underlayer 20 illustrated in FIG. 1 is provided above the substrate 10. This underlayer 20 includes a layer including MgO.

The layer including MgO, is preferably formed substantially of MgO, and is more preferably formed solely of MgO. The layer “formed substantially of MgO” refers to a layer which may include, in addition to MgO, impurities that may inevitably be included in the layer during the manufacturing process of the layer.

In the present embodiment, the underlayer 20 is preferably in direct contact with the first magnetic recording layer 31. In this case, the (100) plane of the MgO included in the underlayer 20, and the (001) plane of the magnetic alloy having the L1₀ crystal structure and included in the first magnetic recording layer 31, are easily lattice matched. For this reason, it is possible to increase the crystal orientation of the magnetic alloy.

The underlayer 20 preferably includes a NaCl-type compound. Examples of the NaCl-type compound, other than MgO, include, TiO, NiO, TiN, TaN, TaN, HfN, NbN, ZrC, HfC, TaC, NbC, TiC, or the like, and two or more kinds of such compounds may be used in combination.

The underlayer 20 may have a multi-layer structure including other layers, provided that the (001) plane orientation of the magnetic grains having the L1₀ crystal structure and included in the magnetic layer 30, can be promoted by the underlayer 20.

The magnetic layer 30 is provided above the underlayer 20. The magnetic layer 30 includes the first magnetic recording layer 31, the second magnetic recording layer 32, and the third magnetic recording layer 33 which are successively laminated in this order above the underlayer 20. The magnetic layer 30 may be formed solely by the first magnetic recording layer 31, the second magnetic recording layer 32, and the third magnetic recording layer 33. Further, the magnetic layer 30 may further include one or more magnetic recording layers other than the first magnetic recording layer 31, the second magnetic recording layer 32, and the third magnetic recording layer 33.

The magnetic layer 30 includes the magnetic grains having the Llo crystal structure. In other words, each of the first magnetic recording layer 31, the second magnetic recording layer 32, and the third magnetic recording layer 33 included in the magnetic layer 30, includes the magnetic grains having the L1₀ crystal structure.

An average grain diameter of the magnetic grains of the first magnetic recording layer 31 at a bottom surface portion of the first magnetic recording layer 31, is set smaller by 15% or more, and more preferably smaller in a range of 30% to 60%, than average grain diameters of the magnetic grains of the second magnetic recording layer 32 and the third magnetic recording layer 33 at bottom surface portions of the second magnetic recording layer 32 and the third magnetic recording layer 33. By setting the average grain diameters of the magnetic grains in this manner, it is possible to prevent an increase of the magnetic grain size, and to reduce the variation in the average grain diameter of the magnetic grains at the bottom surface portion of the magnetic recording layer.

The average grain diameter of the magnetic grains at the bottom portion of the magnetic recording layer refers to the average grain diameter of the magnetic grains at a lower interface portion of the magnetic recording layer. In other words, because the magnetic grains forming the underlayer 20, the first magnetic recording layer 31, the second magnetic recording layer 32, and the third magnetic recording layer 33 are grown epitaxially, these magnetic grains grow to form continuous columnar crystals. Among these columnar crystals, the average grain diameter of the magnetic grains at the interface portion between the underlayer 20 and the first magnetic recording layer 31 is regarded as the average grain diameter of the magnetic grains of the first magnetic recording layer 31 at the bottom surface portion of the first magnetic recording layer 31. The average grain diameter of the magnetic grains at the interface portion between the first magnetic recording layer 31 and the second magnetic recording layer 32 is regarded as the average grain diameter of the magnetic grains forming the second magnetic recording layer 32 at the bottom surface portion of the second magnetic recording layer 32. The average grain diameter of the magnetic grains at the interface portion between the second magnetic recording layer 32 and the third magnetic recording layer 33 is regarded as the average grain diameter of the magnetic grains forming the third magnetic recording layer 33 at the bottom surface portion of the third magnetic recording layer 33.

In the present embodiment, the average grain diameter of the magnetic grains at the bottom surface portion of the magnetic grains is observed using a scanning electron microscope (SEM) or a transmission electron microscope (TEM). For example, when a cross section of the magnetic recording layer is observed using the TEM, depth information of the cross section can be obtained because an electron beam can be transmitted through 10 nm or more. By analyzing the cross sectional information, it is possible to measure the average grain diameter of the magnetic grains.

A Curie temperature Tc of the second magnetic recording layer 32 is set lower than Curie temperatures Tc of the first magnetic recording layer 31 and the third magnetic recording layer 32, to a value lower than each of the Curie temperatures Tc of the first magnetic recording layer 31 and the third magnetic recording layer 32 by a value which falls within a range of 30 K to 100 K. As described above, the volume of the magnetic grains forming the first magnetic recording layer 31 is small compared to the volumes of the magnetic grains forming the second magnetic recording layer 32 and the third magnetic recording layer 33. For this reason, the magnetic characteristics of the first magnetic recording layer 31 is weaker compared to the magnetic characteristics of the second magnetic recording layer 32 which makes contact with the first magnetic recording layer 31. In the present embodiment, the Curie temperature Tc of the second magnetic recording layer 32 is set lower than the Curie temperature Tc of each of the first magnetic recording layer 31 and the third magnetic recording layer 33, by a value which falls within a predetermined range, so as to enhance the magnetic characteristics of the first magnetic recording layer 31. Hence, it is possible to enhance the magnetic characteristics of the first magnetic recording layer 31, and to reduce noise caused by the first magnetic recording layer 31.

FIG. 2 is a TEM photograph illustrating an example of the cross section of the magnetic recording medium 1 according to the present embodiment. The magnetic recording medium 1 illustrated in FIG. 2 has a structure in which the underlayer 20 including MgO, the first magnetic recording layer 31, the second magnetic recording layer 32, the third magnetic recording layer 33, and a protection layer 40 are successively laminated in this order on the substrate 10. Three broken lines in FIG. 2, from the bottom to top, indicate the average grain diameter of the magnetic grains forming the first magnetic recording layer 31 at the bottom surface portion of the first magnetic recording layer 31, the average grain diameter of the magnetic grains forming the second magnetic recording layer 32 at the bottom surface portion of the second magnetic recording layer 32, and the average grain diameter of the magnetic grains forming the third magnetic recording layer 33 at the bottom surface portion of the third magnetic recording layer 33, respectively. Because compositions of the materials forming the first magnetic recording layer 31, the second magnetic recording layer 32, and the third magnetic recording layer 33 are different, respective boundary positions can be distinguished from the contrast differences in the TEM photograph. It can be confirmed from the TEM photograph that the average grain diameter of the magnetic grains forming the first magnetic recording layer 31 at the bottom surface portion of the first magnetic recording layer 31, is smaller than each of the average grain diameter of the magnetic grains forming the second magnetic recording layer 32 at the bottom surface portion of the second magnetic recording layer 32, and the average grain diameter of the magnetic grains forming the third magnetic recording layer 33 at the bottom surface portion of the third magnetic recording layer 33.

As a method of setting the average grain diameter of the magnetic grains forming the first magnetic recording layer 31 at the bottom surface portion of the first magnetic recording layer 31 smaller in a range of 5% to 40%, than each of the average grain diameter of the magnetic grains forming the second magnetic recording layer 32 at the bottom surface portion of the second magnetic recording layer 32, and the average grain diameter of the magnetic grains forming the third magnetic recording layer 33 at the bottom surface portion of the third magnetic recording layer 33, it is possible to employ methods, such as a method which deposits the first magnetic recording layer 31 by sputtering, and applies a positive bias potential to the substrate 10, for example. In other words, the sputtering may set a target to a negative potential, and cause high-speed collision of positively charged sputtering particles of Ar or the like onto the target. This collision causes target grains (or particles) to be ejected from the target surface, to thereby deposit the target material on the substrate surface. Hence, when the positive bias potential is applied to the substrate, the energy of sputtering particle motion decreases to decrease the mobility thereof, and simultaneously decreases the mobility of the target grains (or particles) ejected from the target surface. As a result, it is possible to reduce the grain diameter of the magnetic grains by employing the methods such as that described above.

A thickness of the first magnetic recording layer 31 is preferably in a range of 0.4 nm to 1.5 nm, more preferably in a range of 0.5 nm to 1.0 nm, and even more preferably in a range of 0.6 nm to 0.8 nm. As long as the thickness of the first magnetic recording layer 31 falls within the preferred ranges described above, it is possible to withstand the tensile stress generated at the interface between the first magnetic recording layer 31 and the second magnetic recording layer 32, thereby enabling the first magnetic recording layer 31 to exhibit the magnetic characteristics.

In the present embodiment, the thickness of the first magnetic recording layer 31 refers to a length in a direction perpendicular to a principal surface of the first magnetic recording layer 31. The thickness of the first magnetic recording layer 31 may be a thickness measured at an arbitrary location in the cross section of the first magnetic recording layer 31, for example. When the thickness is measured at a plurality of arbitrary locations in the cross section of the first magnetic recording layer 31, an average value of the thicknesses measured at the plurality of arbitrary locations may be regarded as the thickness of the first magnetic recording layer 31.

A thickness of the second magnetic recording layer 32 is preferably in a range of 0.8 nm to 3.0 nm, more preferably in a range of 1.0 nm to 2.5 nm, and even more preferably in a range of 1.2 nm to 2.0 nm. As long as the thickness of the second magnetic recording layer 32 falls within the preferred ranges described above, it is possible to withstand the tensile stress generated at the interface between the second magnetic recording layer 32 and the first magnetic recording layer 31 or the third magnetic recording layer 33, thereby enabling the second magnetic recording layer 32 to exhibit the magnetic characteristics.

A thickness of the third magnetic recording layer 33 is preferably greater than or equal to 3 nm, more preferably in a range of 3.5 nm to 10.0 nm, and even more preferably in a range of 4.5 nm to 6.0 nm. As long as the thickness of the third magnetic recording layer 33 falls within the preferred ranges described above, it is possible to withstand the tensile stress generated at the interface between the the third magnetic recording layer 33 and the second magnetic recording layer 32, thereby enabling the third magnetic recording layer 33 to exhibit the magnetic characteristics.

When the thicknesses of the first magnetic recording layer 31, the second magnetic recording layer 32, and the third magnetic recording layer 33 fall within the respective preferred ranges described above, it is possible to withstand the effects of the tensile stress generated at the interface between each two mutually adjacent magnetic recording layers, thereby improving the electromagnetic conversion characteristics of the magnetic recording medium 1.

Examples of the magnetic grains having the L1₀ crystal structure, included in the magnetic layer 30, include FePt alloy grains, CoPt alloy grains, or the like, for example. A crystal magnetic anisotropy constant (Ku) of the FePt alloy is less than or equal to 7 ×10⁶ J/m³, and a Ku of the CoPt alloy is less than or equal to 5 ×10⁶ J/m³. Both the FePt alloy and the CoPt alloy are high-Ku materials having a high Ku on the order of 1 ×10⁶ J/m³. For this reason, when the FePt alloy or the CoPt alloy is included in the magnetic layer 30, the grain size of the magnetic grains forming the magnetic layer 30 can be reduced to a grain diameter of 6 nm or less, for example, while maintaining thermal stability.

The magnetic layer 30 may have a granular structure including grain boundary portions.

When the magnetic layer 30 has the granular structure, a content of the grain boundary portions in the magnetic layer 30 is preferably in a range of 25 volume percent (hereinafter simply referred to as “vol%”) to 50 vol%, and more preferably in a range of 35 vol% to 45 vol%. The anisotropy of the magnetic grains included in the magnetic layer 30 can be increased, when the content of the grain boundary portions in the magnetic layer 30 falls within the preferred ranges described above.

Examples of the grain boundary portions include carbide, nitride, oxide, boride, or the like, for example. More specific examples of such grain boundary portions include BN, B₄C, C, MoO_{3,} GeO_{2,} or the like, for example.

The magnetic grains included in the magnetic layer 30 are c-axis oriented, that is, (001) plane oriented, with respect to the substrate 10. A method of causing the c-axis orientation of the magnetic grains included in the magnetic layer 30 with respect to the substrate 10, is not particularly limited. For example, it is possible to employ a method of epitaxially growing the magnetic layer 30 in the c-axis direction, using the underlayer 20.

The magnetic recording medium 1 preferably further includes the protection layer 40 provided on the magnetic layer 30. The protection layer 40 has a function to protect the magnetic recording medium 1 from damage caused by contact between the magnetic recording medium 1 and a magnetic head or the like.

The protection layer 40 may includes a hard carbon film or the like, for example.

Examples of a method of forming the protection layer 40 include Radio Frequency-Chemical Vapor Deposition (RF-CVD) which deposits the layer by decomposing hydrocarbon gas (source gas) by high-frequency plasma, an Ion Beam Deposition (IBD) which deposits the layer by ionizing a source gas by electrons emitted from a filament, a Filtered Cathodic Vacuum Arc (FCVA) which deposits the layer using a solid carbon target without using a source gas, or the like, for example.

A thickness of the protection layer 40 is preferably in a range of 1 nm to 6 nm. When the thickness of the protection layer 40 is greater than or equal to 1 nm, excellent floating characteristics of the magnetic head can be obtained, the magnetic spacing is reduced, and a Signal-to-Noise Ratio (SNR) of the magnetic recording medium 1 is improved.

The magnetic recording medium 1 may further include a lubricant layer 50 provided on the protection layer 40.

Examples of a lubricant forming the lubricant layer 50 include fluoropolymers, such as perfluoro- polyether, or the like, for example.

The magnetic recording medium 1 according to the present embodiment includes the substrate 10, the underlayer 20, and the magnetic layer 30 which are laminated in this order, the underlayer 20 includes MgO, and the magnetic layer 30 includes the first magnetic recording layer 31, the second magnetic recording layer 32, and the third magnetic recording layer 33 which are laminated in this order from the side closer to the substrate 10. In addition, in the magnetic recording medium 1, the Curie temperature Tc of the second magnetic recording layer 32 is lower than of the Curie temperatures Tc of the first magnetic recording layer 31 and the third magnetic recording layer 32, and lower than each of the Curie temperatures Tc of the first magnetic recording layer 31 and the third magnetic recording layer 32 by the value which falls within the range of 30 K to 100 K, and the average grain diameter of magnetic grains of the first magnetic recording layer 31 at the bottom surface portion of the first magnetic recording layer 31, is smaller by 15% or more than average grain diameters of magnetic grains of the second magnetic recording layer 32 and the third magnetic recording layer 33 at bottom surface portions of the second magnetic recording layer 32 and the third magnetic recording layer 33. Because the average grain diameter of magnetic grains at the bottom surface portion of the first magnetic recording layer 31 is smaller by 15% or more than average grain diameters of magnetic grains at the bottom surface portions of the second magnetic recording layer 32 and the third magnetic recording layer 33, the magnetic characteristics of the first magnetic recording layer 31 would normally become lower than the magnetic characteristics of the second magnetic recording layer 32 and the third magnetic recording layer 33 by an amount corresponding to the smaller average grain diameter. However, in the present embodiment, because the Curie temperature Tc of the second magnetic recording layer 32 is lower than each of the Curie temperatures Tc of the first magnetic recording layer 31 and the third magnetic recording layer 32, by the value which falls within the predetermined range, the magnetic characteristics of the second magnetic recording layer 32 can act to enhance the magnetic characteristics of the first magnetic recording layer 31 and the third magnetic recording layer 33. For this reason, even if the magnetic characteristics of the first magnetic recording layer 31 are lower than the magnetic characteristics of the second magnetic recording layer 32 in direct contact with the first magnetic recording layer 31 and the third magnetic recording layer 33 in indirect contact with the first magnetic recording layer 31, it is possible to increase the magnetic characteristics of the first magnetic recording layer 31 by the second magnetic recording layer 32 and the third magnetic recording layer 33. Hence, it is possible to enhance the magnetic characteristics of the first magnetic recording layer 31, and to reduce the noise caused by the first magnetic recording layer 31. As a result, the magnetic recording medium 1 can exhibit excellent electromagnetic conversion characteristics.

The electromagnetic conversion characteristics of the magnetic recording medium 1 can be evaluated from the SNR. It can be evaluated that, the smaller the SNR of the magnetic recording medium 1, the more excellent the electromagnetic conversion characteristics of the magnetic recording medium 1 are. A method of measuring the SNR is not particularly limited, and may be measured using a read/write analyzer RWA1632 and a spin stand S1701MP (both manufactured by GUZIK Technical Enterprises), for example.

The magnetic recording medium 1 can include the magnetic grains in each of the magnetic recording layers of the magnetic layer 30, in a state where the average grain diameter of the magnetic grains at the bottom surface portion of the first magnetic recording layer 31 is set smaller, in the range of 30% to 60%, than the average grain diameters of the magnetic grains at the bottom surface portions of the second magnetic recording layer 32 and the third magnetic recording layer 33. Even when the grain size of the magnetic grains forming the first magnetic recording layer 31 is smaller, within the range described above, with respect to the grain size of the magnetic grains forming the second magnetic recording layer 32 and the third magnetic recording layer 33, it is possible to enhance the magnetic characteristics of the first magnetic recording layer 31, and to reduce the noise caused by the first magnetic recording layer 31. Accordingly, the magnetic recording medium 1 can exhibit excellent electromagnetic conversion characteristics.

In the magnetic recording medium 1, the thickness of the first magnetic recording layer 31 can be in the range of 0.4 nm to 1.5 nm. Hence, because the first magnetic recording layer 31 can sufficiently exhibit the magnetic characteristics, the magnetic recording medium 1 can positively exhibit the excellent electromagnetic conversion characteristics.

In the magnetic recording medium 1, the thickness of the second magnetic recording layer 32 can be in the range of 0.8 nm to 3.0 nm. Accordingly, because the second magnetic recording layer 32 can sufficiently exhibit the magnetic characteristics, the magnetic recording medium 1 can positively exhibit the excellent electromagnetic conversion characteristics.

In the magnetic recording medium 1, the thickness of the third magnetic recording layer 33 can be greater than or equal to 3 nm. Thus, because the third magnetic recording layer 33 can sufficiently exhibit the magnetic characteristics, the magnetic recording medium 1 can positively exhibit the excellent electromagnetic conversion characteristics.

The magnetic recording medium 1 can include at least one of the FePt alloy and the CoPt alloy having the L1₀ crystal structure. Both the FePt alloy and the CoPt alloy are high-Ku materials having a high Ku on the order of 1 ×10⁶ J/m³. For this reason, by using at least one of the FePt alloy and the CoPt alloy as the material forming the magnetic layer 30, the grain size of the magnetic grains forming the magnetic layer 30 can be reduced to the grain diameter of 6 nm or less, for example, while maintaining the thermal stability. Hence, when the thermal assist recording method or the microwave assist recording method is used as the recording method, the magnetic layer 30 can have a coercivity of several tens of kOe at room temperature, and magnetic information can easily be recorded in the magnetic layer 30 by a magnetic recording field of the magnetic head.

[Magnetic Storage Apparatus]

Next, a magnetic storage apparatus using the magnetic recording medium according to the present embodiment will be described. The magnetic storage apparatus according to the present embodiment is not particularly limited to a specific type, as long as the magnetic recording medium according to the present embodiment is included therein. Hereinafter, an example in which the magnetic information is recorded on the magnetic recording medium by the magnetic storage apparatus using the thermal assist recording method will be described.

For example, the magnetic storage apparatus according to the present embodiment includes a driving mechanism which drives the magnetic recording medium to rotate in a recording direction, and a magnetic head having a near-field light generator (or near-field light generating element) provided on a tip end thereof. The magnetic storage apparatus further includes a head moving mechanism which moves the magnetic head, and a signal processor which processes signals input to the magnetic head to be recorded on the magnetic recording medium, and processes signals reproduced from the magnetic recording medium by the magnetic head and output from the magnetic head.

The magnetic head further has a laser generator which generates laser light for heating the magnetic recording medium, and a waveguide which guides the laser light generated from the laser generator to the near-field light generator.

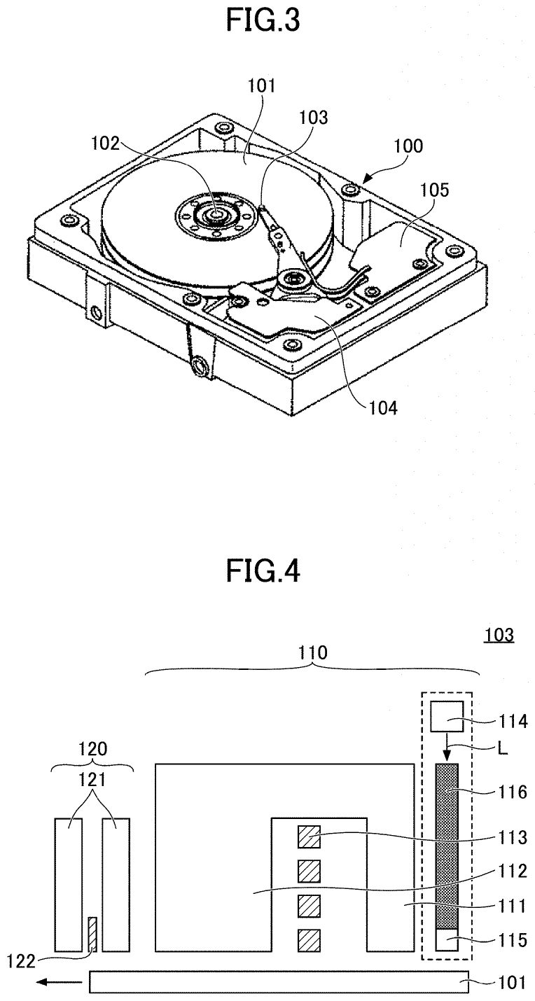

FIG. 3 illustrates an example of the magnetic storage apparatus using the magnetic recording medium according to the present embodiment. As illustrated in FIG. 3, a magnetic storage apparatus 100 includes one or a plurality of magnetic recording media 101, a driving mechanism 102 which drives the magnetic recording medium 101 to rotate, a magnetic head 103, a head moving mechanism 104 which moves the magnetic head 103, and a signal processor 105. The signal processor 105 processes signals which are input to the magnetic head 103 to be recorded on the magnetic recording medium 101, and processes signals which are reproduced from the magnetic recording medium 101 by the magnetic head 103 and output from the magnetic head 103. The magnetic recording medium 1 illustrated in FIG. 1 may be used as the magnetic recording medium 101. For example, the magnetic recording medium 101 may have a disk shape, and in this case, the magnetic storage apparatus may form a Hard Disk Drive (HDD).

FIG. 4 is a schematic diagram illustrating an example of the magnetic head 103 is illustrated in FIG. 3. The magnetic head 103 illustrated in FIG. 4 includes a recording (or write) head 110 which records (or writes) signals to the magnetic recording medium 101, and a reproducing (or read) head 120 which reproduces (or reads) signals from the magnetic recording medium 101.

The recording head 110 includes a main magnetic pole 111, an auxiliary magnetic pole 112, a coil 113 which generates a magnetic field, a laser diode (LD) 114 which is an example of the laser generator and generates laser light L, a near-field light generator (or near-field light generating element) 115 which generates near-field light for heating the magnetic recording medium 101, and a waveguide 116. The waveguide 116 guides the laser light L generated from the laser diode 114 to the near-field light generator 115 which is provided on a tip end of the magnetic head 103.

The reproducing head 120 includes a reproducing element 122, such as a TMR (Tunneling Magneto-Resistive) element or the like, for example, that is sandwiched between a pair of shields 121.

As illustrated in FIG. 3, in the magnetic storage apparatus 100, a central portion of the magnetic recording medium 101 is attached to a rotating shaft of a spindle motor, and records information on and reproduces information from the magnetic recording medium 101 in a state where the magnetic head 103 moves while floating above a surface of the magnetic recording medium 101 which is driven to rotate by the spindle motor.

The magnetic storage apparatus 100 according to the present embodiment can increase the recording density, because it is possible to increase the recording density of the magnetic recording medium 101 by using the magnetic recording medium 1 according to the present embodiment as the magnetic recording medium 101.

Of course, the magnetic storage apparatus 100 may use a magnetic head which conforms to the microwave assist recording method, in place of the magnetic head 103 which conforms to the thermal assist recording method.

[Exemplary Implementations]

Next, exemplary implementations according to the present invention, and comparative examples, will be described. The present invention is not limited to these exemplary implementations, and various variations and modifications may be made without departing from the scope of the present invention. In the following, “at%” represents “atomic percent”, and “mol%” represents “mole percent”.

<Method of Manufacturing Magnetic Recording Medium>

[Exemplary Implementation EI1]

Magnetic recording media were manufactured by the following methods.

A Cr-50at%Ti alloy layer having a thickness of 100 nm, and a Co-27at%Fe-5at%Zr-5at%B alloy layer having a thickness of 30 nm, were successively famed on a glass substrate, as the underlayer. Next, after heating the glass substrate to 250° C., a Cr layer having a thickness of 10 nm, and a MgO layer having a thickness of 5 nm, were also successively formed, as the underlayer. Then, after heating the glass substrate to 450° C., a FePt-40mol %C layer having a thickness of 1 nm was formed, as the first magnetic recording layer, by applying a bias potential of +10 V to the substrate. Next, after heating the glass substrate to 630° C., a FePt5at%Rh-40mol %C layer having a thickness of 2 nm was formed, as the second magnetic recording layer. Further, a FePt-16SiO₂ layer having a thickness of 3 nm was famed, as the third magnetic recording layer. Next, a carbon film having a thickness of 3 nm was formed, as the protection layer, thereby forming the magnetic recording medium according to an exemplary implementation EI1.

[Exemplary Implementations EI2 to EI11, and Comparative Examples CE1-1 to CE1-5]

The magnetic recording media according to exemplary implementations EI2 to EI11, and the magnetic recording media according to comparative examples CE1-1 to CE1-5, were manufactured in the same manner as the magnetic recording medium according to the exemplary implementation EI1, except that the material forming at least one of the first magnetic recording layer, the second magnetic recording layer, and the third magnetic recording layer was modified as illustrated in Table 1.

[Comparative Examples CE2-1 to CE2-4]

The magnetic recording media according to comparative examples CE2-1 to CE2-4 were manufactured in the same manner as the magnetic recording medium according to the exemplary implementation EI1, except that the temperature of the glass substrate during deposition of the first magnetic recording layer was set to 650° C., and no bias potential was applied to the glass substrate during the deposition of the first magnetic recording layer. [Comparative Example CE3-1]

The magnetic recording medium according to comparative example CE3-1 was manufactured in the same manner as the magnetic recording medium according to the exemplary implementation EI1, except that the materials forming the magnetic layer were changed as illustrated in Table 1, and no bias potential was applied to the glass substrate during the deposition of the first magnetic recording layer.

Cross sections of the manufactured magnetic recording media according to the exemplary implementations EI1to EI11, and the comparative examples CE1-1 to CE1-5, CE2-1 to CE2-4, and CE3-1 were observed by the TEM, to measure the average grain diameter of the magnetic grains of the first magnetic recording layer at the bottom surface portion of the first magnetic recording layer, the average grain diameter of the magnetic grains of the second magnetic recording layer at the bottom surface portion of the second magnetic recording layer, and the average grain diameter of the magnetic grains of the third magnetic recording layer at the bottom surface portion of the third magnetic recording layer. Results of the measurements are illustrated in Table 1.

In Table 1, “1ST Layer” represents the first magnetic recording layer, “2ND Layer” represents the second magnetic recording layer, and “3RD Layer” represents the third magnetic recording layer. Further, “Dₐᵥ₁” represents the average grain diameter of the magnetic grains of the first magnetic recording layer at the bottom surface portion of the first magnetic recording layer, “Dₐᵥ₂” represents the average grain diameter of the magnetic grains of the second magnetic recording layer at the bottom surface portion of the second magnetic recording layer, and “Dₐᵥ₃” represents the average grain diameter of the magnetic grains of the third magnetic recording layer at the bottom surface portion of the third magnetic recording layer.

<Evaluation of Magnetic Recording Medium>

(Electromagnetic Conversion Characteristics)

The SNR was evaluated as the electromagnetic conversion characteristics of the manufactured magnetic recording media according to the exemplary implementations EI1 to EI11, and the comparative examples CE1-1 to CE1-5, CE2-1 to CE2-4, and CE3-1, using the read/write analyzer RWA1632 and the spin stand S1701MP (both manufactured by GUZIK Technical Enterprises).

TABLE 1

| | 1ST Layer | | | 2ND Layer | | |
|---|---|---|---|---|---|---|
| | | Thickness | Tc | | Thickness | Tc |
| | Composition | [nm] | [K] | Composition | [nm] | [K] |
| EI1 | FePt—40C | 1.00 | 650 | FePt—5Rh—40C | 2.0 | 580 |
| EI2 | FePt—40C | 1.00 | 650 | FePt—2.5Rh—40C | 2.0 | 620 |
| EI3 | FePt—40C | 1.00 | 650 | FePt—2.5Ir—40C | 2.0 | 590 |
| EI4 | FePt—40C | 1.00 | 650 | FePt—1.6Ir—40C | 2.0 | 620 |
| EI5 | FePt—40C | 1.00 | 650 | FePt—5Rh—40C | 2.0 | 580 |
| EI6 | FePt—40C | 1.00 | 650 | FePt—5Rh—40C | 2.0 | 580 |
| EI7 | FePt—40C | 1.00 | 650 | FePt—5Rh—40C | 2.0 | 580 |
| EI8 | FePt—40C | 1.00 | 650 | FePt—5Rh—40C | 2.5 | 580 |
| EI9 | FePt—40C | 1.00 | 650 | FePt—5Rh—40C | 3.0 | 580 |
| EI10 | FePt—40C | 0.80 | 650 | FePt—5Rh—40C | 2.0 | 580 |
| EI11 | FePt—40C | 1.50 | 650 | FePt—5Rh—40C | 2.0 | 580 |
| CE1-1 | FePt—40C | 1.00 | 650 | FePt—40C | 2.0 | 700 |
| CE1-2 | FePt—40C | 1.00 | 650 | FePt—1Rh—40C | 2.0 | 675 |
| CE1-3 | FePt—40C | 1.00 | 650 | FePt—0.5Ir—40C | 2.0 | 660 |
| CE1-4 | FePt—40C | 1.00 | 650 | FePt—5Rh—40C | 2.0 | 610 |
| CE1-5 | FePt—5Rh—40C | 1.00 | 580 | FePt—5Rh—40C | 2.0 | 580 |
| CE2-1 | FePt—40C | 1.00 | 450 | FePt—2.5Rh—40C | 2.0 | 620 |
| CE2-2 | FePt—40C | 1.00 | 650 | FePt—2.5Rh—40C | 2.0 | 620 |
| CE2-3 | FePt—20C | 0.75 | 650 | FePt—2.5Rh—40C | 2.0 | 620 |
| CE2-4 | FePt—25Ag | 1.00 | 650 | FePt—2.5Rh—40C | 2.0 | 620 |
| CE3-1 | FePt—40C | 1.00 | 650 | FePt—5Rh—40C | 1.0 | 580 |

| | 3RD Layer | | | | | | |
|---|---|---|---|---|---|---|---|
| | | Thickness | Tc | Dₐᵥ₁ | Dₐᵥ₂ | Dₐᵥ₃ | |
| | Composition | [nm] | [K] | [nm] | [nm] | [nm] | SNR |
| EI1 | FePt—16SiO₂ | 3.0 | 700 | 4.5 | 8.5 | 8.5 | 6.7 |
| EI2 | FePt—16SiO₂ | 3.0 | 700 | 4.5 | 8.5 | 8.5 | 6.5 |
| EI3 | FePt—16SiO₂ | 3.0 | 700 | 4.5 | 8.5 | 8.5 | 6.6 |
| EI4 | FePt—16SiO₂ | 3.0 | 700 | 4.5 | 8.5 | 8.5 | 6.3 |
| EI5 | FePt—10SiO₂—18BN | 3.0 | 700 | 4.5 | 8.5 | 8.5 | 6.9 |
| EI6 | FePt—16SiO₂ | 4.5 | 700 | 4.5 | 8.5 | 8.7 | 7.1 |
| EI7 | FePt—16SiO₂ | 6.0 | 700 | 4.5 | 8.5 | 8.8 | 6.9 |
| EI8 | FePt—16SiO₂ | 3.0 | 700 | 4.5 | 8.7 | 8.7 | 6.5 |
| EI9 | FePt—16SiO₂ | 3.0 | 700 | 4.5 | 8.8 | 8.8 | 6.3 |
| EI10 | FePt—16SiO₂ | 3.0 | 700 | 4.5 | 8.5 | 8.5 | 6.6 |
| EI11 | FePt—16SiO₂ | 3.0 | 700 | 5.5 | 8.5 | 8.5 | 6.2 |
| CE1-1 | FePt—16SiO₂ | 3.0 | 700 | 4.5 | 8.5 | 8.5 | 3.2 |
| CE1-2 | FePt—16SiO₂ | 3.0 | 700 | 4.5 | 8.5 | 8.5 | 5.0 |
| CE1-3 | FePt—16SiO₂ | 3.0 | 700 | 4.5 | 8.5 | 8.5 | 4.6 |
| CE1-4 | FePt—8Rh—16SiO₂ | 3.0 | 520 | 4.5 | 8.5 | 8.5 | 5.8 |
| CE1-5 | FePt—16SiO₂ | 3.0 | 700 | 4.5 | 8.5 | 8.5 | 5.5 |
| CE2-1 | FePt—16SiO₂ | 3.0 | 700 | 8.0 | 8.8 | 8.8 | 5.5 |
| CE2-2 | FePt—16SiO₂ | 3.0 | 700 | 8.0 | 8.7 | 8.7 | 5.8 |
| CE2-3 | FePt—16SiO₂ | 3.0 | 700 | 8.8 | 9.1 | 9.1 | 4.5 |
| CE2-4 | FePt—16SiO₂ | 3.0 | 700 | 8.5 | 9.2 | 9.2 | 4.8 |
| CE3-1 | FePt—16SiO₂ | 3.0 | 700 | 4.5 | 5.0 | 8.8 | 3.3 |

As illustrated in Table 1, the SNR was 6.2 or greater for the exemplary implementations EI1 to EI11. On the other hand, the SNR was 5.8 or less for the comparative examples CE1-1 to CE1-5, CE2-1 to CE2-4, and CE3-1.

Accordingly, unlike the magnetic recording media according to the comparative examples CE1-1 to CE1-5, CE2-1 to CE2-4, and CE3-1, in the magnetic recording media according to the exemplary implementations EI1 to EI11, the Curie temperature of the second magnetic recording layer is lower than each of the Curie temperatures of the first magnetic recording layer and the third magnetic recording layer, by the value which falls within the range of 30 K to 100 K, and the average grain diameter of magnetic grains of the first magnetic layer at the bottom surface portion of the first magnetic recording layer, is smaller by 15% or more than the average grain diameters of magnetic grains of the second magnetic recording layer and the third magnetic recording layer at the bottom surface portions of the second magnetic recording layer and the third magnetic recording layer, respectively. Accordingly, it was confirmed that the magnetic recording medium 1 can exhibit excellent electromagnetic conversion characteristics, because the grain size of the magnetic grains included in the magnetic layer 30 can be reduced.

Therefore, according to the embodiments and exemplary implementations described above, the magnetic recording medium can exhibit excellent electromagnetic conversion characteristics.

Although the exemplary implementations are designated by reference characters “EI1”, “EI2”, “EI3”, or the like, the ordinal numbers “1”, “2”, “3”, or the like appended to “EI” do not imply priorities of the exemplary implementations.

Although the embodiments and exemplary implementations are described above, the present invention is not limited to such embodiments and exemplary implementations. The embodiments and exemplary implementations may be implemented in various other forms, and various combinations, omissions, substitutions, modifications, variations, or the like may be made without departing from the scope of the present invention and equivalents thereof.

What is is claimed is:

1. A magnetic recording medium comprising:
a substrate;
an underlayer, provided on the substrate, and including MgO; and
a magnetic layer, provided on the underlayer, and including an alloy having an L1₀ crystal structure,
wherein the magnetic layer includes three or more magnetic recording layers including a first magnetic recording layer, a second magnetic recording layer, and a third magnetic recording layer which are successively provided in this order above the underlayer,
wherein a Curie temperature of the second magnetic recording layer is lower than Curie temperatures of the first magnetic recording layer and the third magnetic recording layer, and is lower than each of the Curie temperatures of the first magnetic recording layer and the third magnetic recording layer by a value which falls within a range of 30 K to 100 K, and
wherein an average grain diameter of magnetic grains of the first magnetic recording layer at a bottom surface portion of the first magnetic recording layer, is smaller by 15% or more than average grain diameters of magnetic grains of the second magnetic recording layer and the third magnetic recording layer at bottom surface portions of the second magnetic recording layer and the third magnetic recording layer.

2. The magnetic recording medium as claimed in claim 1, wherein the average grain diameter of the first magnetic recording layer at the bottom surface portion of the first magnetic recording layer, is 30% to 60% smaller than the average grain diameters of the second magnetic recording layer and the third magnetic recording layer at the bottom surface portions of the second magnetic recording layer and the third magnetic recording layer.

3. The magnetic recording medium as claimed in claim 1, wherein the first magnetic recording layer has a thickness in a range of 0.4 nm to 1.5 nm.

4. The magnetic recording medium as claimed in claim 4, wherein the second magnetic recording layer has a thickness in a range of 0.8 nm to 3.0 nm.

5. The magnetic recording medium as claimed in claim 4, wherein the third magnetic recording layer has a thickness greater than or equal to 3 nm.

6. The magnetic recording medium as claimed in claim 2, wherein the first magnetic recording layer has a thickness in a range of 0.4 nm to 1.5 nm.

7. The magnetic recording medium as claimed in claim 1, wherein the second magnetic recording layer has a thickness in a range of 0.8 nm to 3.0 nm.

8. The magnetic recording medium as claimed in claim 2, wherein the second magnetic recording layer has a thickness in a range of 0.8 nm to 3.0 nm.

9. The magnetic recording medium as claimed in claim 1, wherein the third magnetic recording layer has a thickness greater than or equal to 3 nm.

10. The magnetic recording medium as claimed in claim 2, wherein the third magnetic recording layer has a thickness greater than or equal to 3 nm.

11. The magnetic recording medium as claimed in claim 1, wherein the underlayer is in direct contact with the first magnetic recording layer.

12. A magnetic storage apparatus comprising:
the magnetic recording medium according to claim 1; and
a magnetic head configured to write information to and read information from the magnetic recording medium.

13. A magnetic storage apparatus comprising:
the magnetic recording medium according to claim 2; and
a magnetic head configured to write information to and read information from the magnetic recording medium.

14. A magnetic storage apparatus comprising:
the magnetic recording medium according to claim 3; and
a magnetic head configured to write information to and read information from the magnetic recording medium.

15. A magnetic storage apparatus comprising:
the magnetic recording medium according to claim 4; and
a magnetic head configured to write information to and read information from the magnetic recording medium.

16. A magnetic storage apparatus comprising:
the magnetic recording medium according to claim 5; and
a magnetic head configured to write information to and read information from the magnetic recording medium.

17. A magnetic storage apparatus comprising:
the magnetic recording medium according to claim 11; and
a magnetic head configured to write information to and read information from the magnetic recording medium.
